(19) United States
(12) Patent Application Publication
(10) Pub. No.: US 2022/0121496 A1
(43) Pub. Date: Apr. 21, 2022

(54) INFORMATION PROCESSING DEVICE AND COMPUTER-READABLE RECORDING MEDIUM STORING APPLICATION CONTROL PROGRAM

(71) Applicant: FUJITSU LIMITED, Kawasaki-shi (JP)

(72) Inventor: Keiji Miyazaki, Kawasaki (JP)

(73) Assignee: FUJITSU LIMITED, Kawasaki-shi (JP)

(21) Appl. No.: 17/373,826

(22) Filed: Jul. 13, 2021

(30) Foreign Application Priority Data
Oct. 16, 2020 (JP) 2020-174570

(51) Int. Cl. G06F 9/50

(52) U.S. Cl. CPC G06F 9/5038; G06F 2209/508; G06F 9/5016; G06F 9/5055

(57) ABSTRACT

An information processing device includes a memory and a processor coupled to the memory. The processor is configured to: refer, in a case where a specific application included in a plurality of applications is executed, refer to a storage unit that stores flow information that indicates an execution order of the plurality of applications in the past and calculate an execution probability that each of one or more applications that may be executed after the specific application among the plurality of applications is executed after the specific application; specify an application to be activated from the one or more applications on the basis of the calculated execution probability; and activate the specified application to be activated.

### CROSS-REFERENCE TO RELATED APPLICATION

This application is based upon and claims the benefit of priority of the prior Japanese Patent Application No. 2020-174570, filed on Oct. 16, 2020, the entire contents of which are incorporated herein by reference.

### FIELD

The embodiment discussed herein is related to an information processing device and an application control program.

### BACKGROUND

For example, a business operator who provides a service to a user (hereinafter, simply referred to as business operator) constructs and operates a business system used to provide the service (hereinafter, also referred to as information processing system).

Japanese Laid-open Patent Publication No. 2018-133046 and Japanese National Publication of International Patent Application No. 2017-527037 are disclosed as related art.

### SUMMARY

According to an aspect of the embodiments, an information processing device includes: a memory; and a processor coupled to the memory and configured to: refer, in a case where a specific application included in a plurality of applications is executed, refer to a storage unit that stores flow information that indicates an execution order of the plurality of applications in the past and calculate an execution probability that each of one or more applications that may be executed after the specific application among the plurality of applications is executed after the specific application; specify an application to be activated from the one or more applications on the basis of the calculated execution probability; and activate the specified application to be activated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a configuration of an information processing system 10;

FIG. 2 is a diagram for explaining a specific example of processing in a container 3;

FIG. 3 is a diagram for explaining a specific example of the processing in the container 3;

FIG. 4 is a diagram for explaining a hardware configuration of a management device 1;

FIG. 5 is a functional block diagram of the management device 1;

FIG. 6 is a flowchart for explaining an outline of application control processing according to a first embodiment;

FIG. 7 is a flowchart for explaining details of the application control processing according to the first embodiment;

FIG. 8 is a flowchart for explaining details of the application control processing according to the first embodiment;

FIG. 9 is a flowchart for explaining details of the application control processing according to the first embodiment;

FIG. 10 is a flowchart for explaining details of the application control processing according to the first embodiment;

FIG. 11 is a flowchart for explaining details of the application control processing according to the first embodiment;

FIG. 12 is a flowchart for explaining details of the application control processing according to the first embodiment;

FIG. 13 is a diagram for explaining a specific example of application information 131;

FIG. 14 is a diagram for explaining a specific example of application event information 132;

FIG. 15 is a diagram for explaining a specific example of machine information 134;

FIG. 16 is a diagram for explaining a specific example of flow information 133;

FIG. 17 is a diagram for explaining details of the application control processing according to the first embodiment;

FIG. 18 is a diagram for explaining details of the application control processing according to the first embodiment;

FIG. 19 is a diagram for explaining a specific example of workflow information 135;

FIG. 20 is a diagram for explaining details of the application control processing according to the first embodiment;

FIG. 21 is a diagram for explaining a specific example of the workflow information 135;

FIG. 22 is a diagram for explaining a specific example of the workflow information 135;

FIG. 23 is a diagram for explaining, a specific example of the workflow information 135;

FIG. 24 is a diagram for explaining a specific example of the workflow information 135; and

FIG. 25 is a diagram for explaining a specific example of the flow information 133.

### DESCRIPTION OF EMBODIMENTS

Specifically, for example, the business operator constructs the business system for providing the service to the user by linking applications that respectively operate in a plurality of containers generated in a physical machine. Then, the business operator, for example, provides a Function as a Service (FaaS) to the user by operating the constructed business system.

Here, in a case where the FaaS as described above is provided, for 1l example, the business system sequentially activates a container in which an application for executing processing corresponding to a processing request operates in response to receipt of the processing request (hereinafter, also referred to as event) from the user. Furthermore, the business system stops the container, in which the application that has executed the processing operates, for example, according to completion of the execution of the processing corresponding to the processing request. This makes it possible for the business operator to efficiently use resources of the physical machine where the container is generated.

However, for example, in a case where an application that executes processing next is determined according to the result of the processing of each application, the business system needs to activate a container in which the application that executes the processing next operates after waiting for the completion of the processing of each application. Therefore, with the business system, for example, there is a case where a response time to the processing request is lengthened depending on the number of applications that execute the processing corresponding the processing request.

Therefore, for example, the business system as described above activates in advance the container in which each application that may be executed after the application that is in execution operates. As a result, for example, even in a case where the number of applications that operate according to the execution of the processing corresponding to the processing request is large, the business operator can shorten the response time to the processing request.

However, as described above, in a case where the container in which each application operates is activated in advance, in the business system, a consumption of a resource (hereinafter, also simply referred to as physical resource) such as a central processing unit (CPU) or a memory increases. Therefore, the business system as described above is required to realize both of suppression of the consumption of the physical resource and reduction in the response time to the processing request.

Therefore, in one aspect, an information processing device and an application control program that can shorten a response time to a processing request while suppressing a consumption of a physical resource may be provided.

[Configuration of Information Processing System]

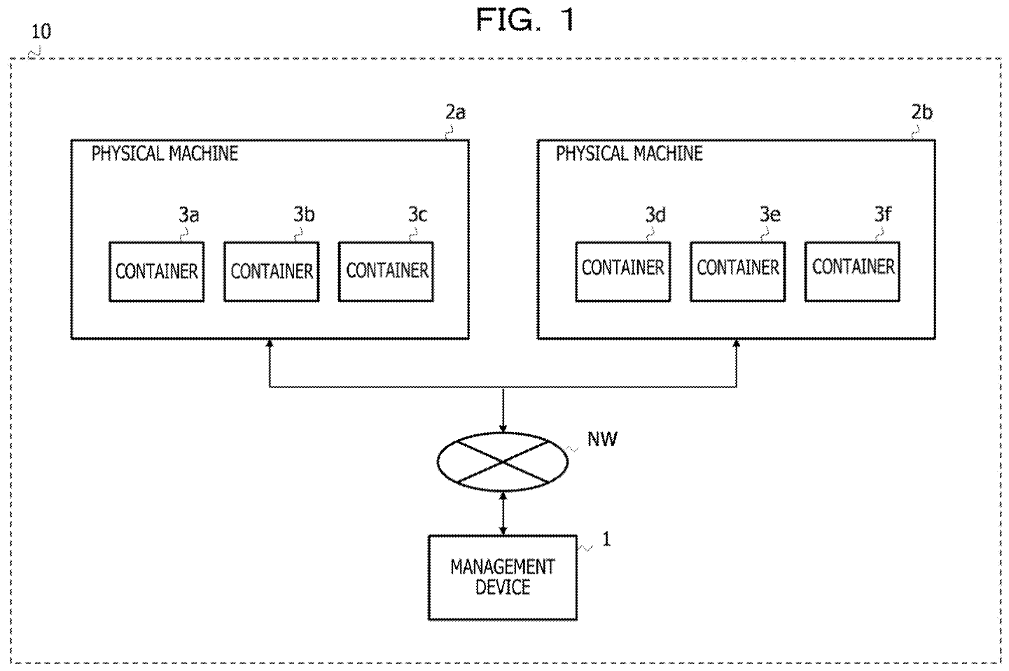

First, a configuration of an information processing system 10 will be described. FIG. 1 is a diagram for explaining the configuration of the information processing system 10.

The information processing system 10 illustrated in FIG. 1 includes a management device 1 and physical machines 2a and 2b. In the physical machine 2a, containers 3a, 3b, and 3c operate, and in the physical machine 2b, containers 3d, 3e, and 3f operate. Hereinafter, the physical machines 2a and 2b are also collectively referred to as a physical machine 2, and the containers 3a, 3b, 3c, 3d, 3e, and 3f are also collectively referred to as a container 3. Note that, in the example in FIG. 1, the information processing system 10 includes the two physical machines 2. However, the number of physical machines 2 included in the information processing system 10 may be other than two. Furthermore, in the example in FIG. 1, the containers 3a, 3b, 3c, 3d, 3e, and 3f operate in the physical machine 2. However, the number of containers 3 that operate may be other than this, and in addition, the number of containers 3 that operate may be changed as needed.

Furthermore, for example, in a case of receiving a processing request transmitted by a user via a user's terminal (not illustrated), the management device 1 specifies a container 3 in which an application (hereinafter, simply referred to as application) that executes processing corresponding to the received processing request operates. Then, the management device 1, for example, activates the specified container 3, and in addition, transmits the processing request received from the user's terminal to the activated container 3. Hereinafter, a specific example of the processing in the container 3 will be described.

### Specific Example of Processing in Container

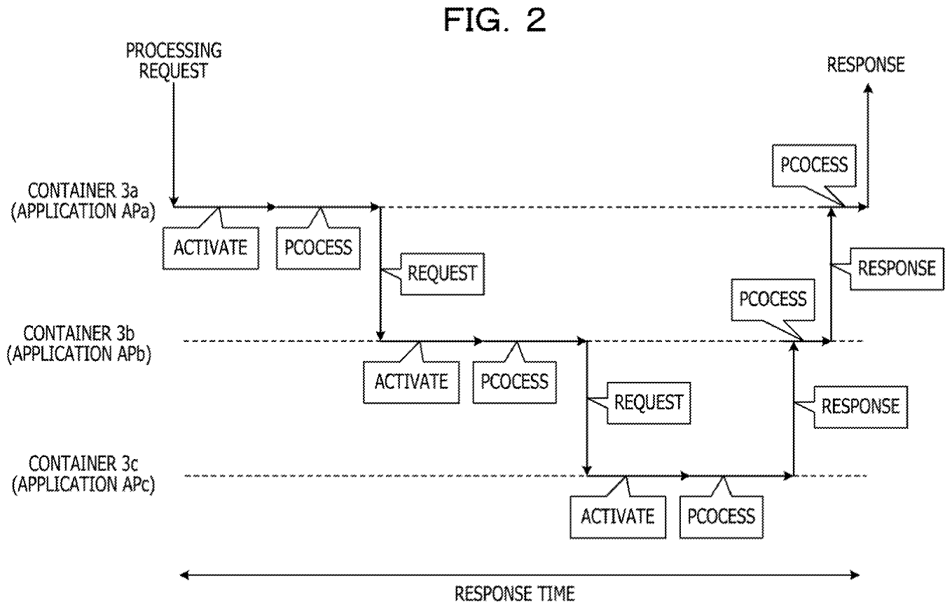

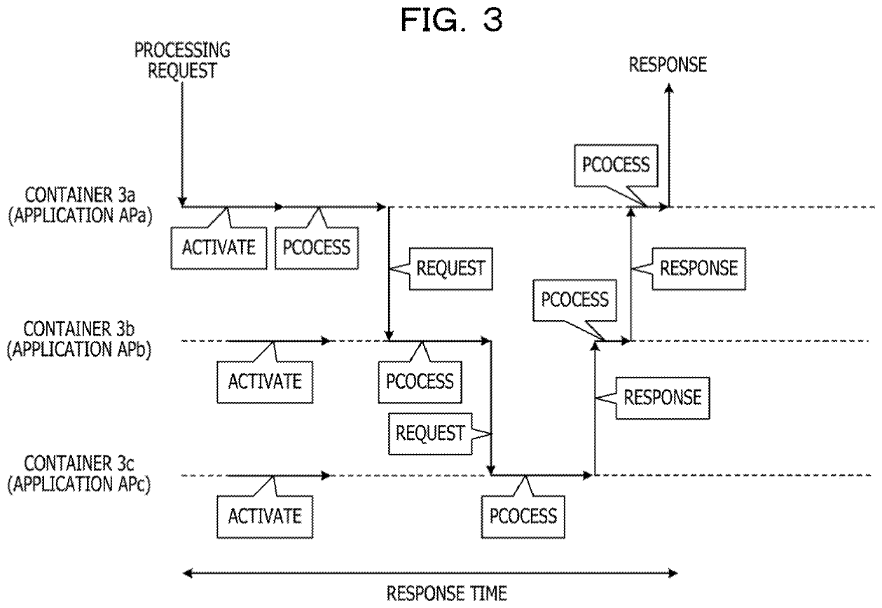

FIGS. 2 and 3 are diagrams for explaining specific examples of the processing in the container 3. Hereinafter, description will be made as assuming that applications APa, APb, and APc respectively operate in the containers 3a, 3b, and 3c. Furthermore, hereinafter, the applications APa, APb, and APc are also collectively referred to as an application AP.

For example, in a case of receiving a processing request that requires to operate the application APa first, as illustrated in FIG. 2, for example, the management device 1 instructs the physical machine 2a that stores an image file (not illustrated) of the container 3a that executes the application APa to activate the container 3a. Then, the management device 1 transmits the received processing request to the container 3a in response to completion of the activation of the container 3a.

Subsequently, the application APa executes processing according to the processing request received from the management device 1 in the container 3a. Then, for example, in a case where the application APb is specified as an application AP to execute processing next as a result of completing the execution of the processing according to the received processing request, for example, the management device 1 instructs the physical machine 2a that stores an image file $ of the container 3b that executes the application APb to activate the container 3b. Moreover, the container 3a transmits, to the container 3b, a processing request that is generated along with the completion of the processing by the application APa.

Next, the application APb executes processing according to the processing request received from the container 3a in the container 3b. Then, for example, in a case where the application APc is specified as an application to execute processing next as a result of completing the execution of the processing according to the received processing request, for example, the management device 1 instructs the physical machine 2a that stores an image file of the container 3c that executes the application APc to activate the container 3c. Moreover, the container 3b transmits, to the container 3c, a processing request that is generated along with the completion of the processing by the application APb.

Subsequently, the application APc executes processing according to the processing request received from the container 3b in the container 3c. Then, for example, in a case where it is determined that no application to execute processing next exists as a result of completing the execution of the processing according to the received processing request, the container 3c, for example, transmits a processing result (response) by the application APc to the container 3b.

Thereafter, the application APb executes necessary processing, for example, on the processing result received from the container 3c, Then, the container 3b transmits a processing result obtained by executing the necessary processing by the application APb to the container 3a.

Moreover, the application APa, for example, executes necessary processing on the processing result received from the container 3b. Then, the container 3a transmits the processing result obtained by executing the necessary processing by the application APa to the user's terminal or the like that has transmitted the processing request to the management device 1.

Here, in a case of the example in FIG. 2, the information processing system 10 sequentially activates the container 3 in which the application AP that executes processing next operates after the processing executed by each application AP is completed. Generally, a time required for execution of the application AP is about several (ms). On the other hand, a time required for activation of the container 3 is about 300 (ms) to several (seconds). Therefore, there is a case where the information processing system 10 takes a longer response time to a user who has transmitted a processing request.

Therefore, for example, the information processing system 10 activates in advance the container 3 in which each application AP that may be executed after the application AP that is in execution operates. Specifically, for example, as illustrated in FIG. 3, the information processing system 10 activates, in advance, the containers 3b and 3c in which the respective applications AP that may be executed after the application APa operate before the execution of the processing by the application APa is terminated. As a result, for example, as illustrated in FIG. 3, a business operator can suppress the response time to the processing request.

However, as described above, in a case where the container 3, in which each application to be executed after the application that is in execution operates, is activated in advance, a consumption amount of a physical resource such as a CPU or a memory increases in the physical machine 2. Therefore, it is preferable for the business operator to adopt a method that can shorten a response time to the processing request while suppressing the consumption of the physical resource of the physical machine 2 in the information processing system 10.

Therefore, in a case where an application AP included in the plurality of applications AP (hereinafter, also referred to as specific application AP) is executed, the management device 1 according to the present embodiment refers to a storage unit that stores flow information indicating the execution order of the plurality of applications AP in the past and calculates an execution probability such that each of one or more applications AP that may be executed after the specific application AP is executed after the specific application AP. Then, the management device 1 specifies an application AP to be activated on the basis of the calculated execution probability, and activates the specified application AP to be activated.

That is, for example, the management device 1 according to the present embodiment specifies the application AP that has a higher possibility to be executed after the specific application AP (application AP with higher execution probability) on the basis of an activation order of each application AP in the past. Then, the management device 1 only activates the specified application AP in advance.

As a result, for example, the management device 1 according to the present embodiment can shorten the response time to the processing request while suppressing the consumption of the physical resource of the physical machine 2.

[Hardware Configuration of Information Processing System]

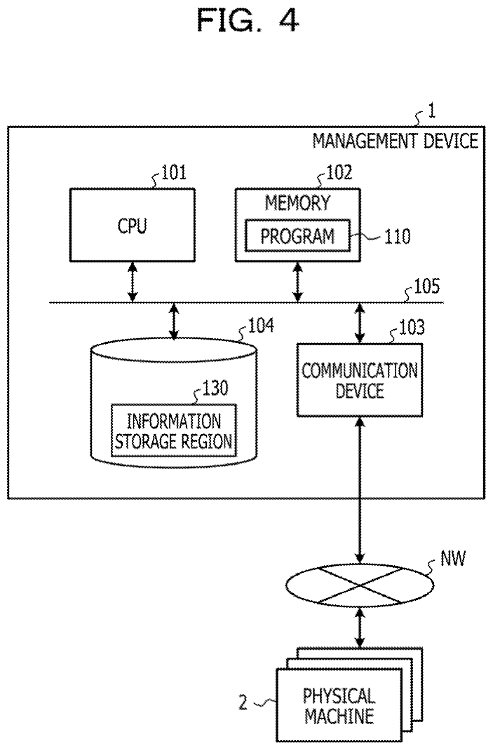

Next, a hardware configuration of the information processing system 10 will be described. FIG. 4 is a diagram for explaining a hardware configuration of the management device 1.

As illustrated in FIG. 4, the management device 1 includes a CPU 101 as a processor, a memory 102, a communication device 103, and a storage medium 104. Each of the units is connected to each other via a bus 105.

The storage medium 104 has, for example, a program storage region (not illustrated) in which a program 110 that executes processing for controlling an activation timing or the like of each application AP (hereinafter, also referred to as application control processing) is stored. Furthermore, the storage medium 104 includes, for example, a storage unit 130 (hereinafter, also referred to as information storage region 130) for storing information to be used when the application control processing is executed. Note that the storage medium 104 may be, for example, a hard disk drive (HDD) or a solid state drive (SSD).

The CPU 101 executes the program 110 that is loaded from the storage medium 104 into the memory 102 so as to execute the application control processing.

Furthermore, the communication device 103 communicates with each physical machine 2, for example, via a network NW.

[Functions of Information Processing System]

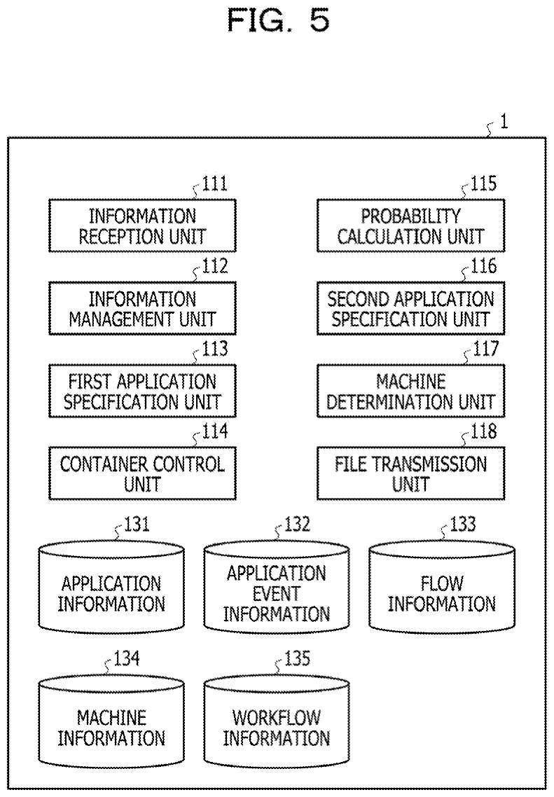

Next, functions of the information processing system 10 will be described. FIG. 5 is a functional block diagram of the management device 1.

As illustrated in FIG. 5, the management device 1 achieves various functions including an information reception unit 111, an information management unit 112, a first application specification unit 113, a container control unit 114 (hereinafter, also referred to as activation control unit 114), a probability calculation unit 115, a second application specification unit 116 (hereinafter, also referred to as target specification unit 116), a machine determination unit 117, and a file transmission unit 118, for example, by organically linking hardware such as the CPU 101 or the memory 102 and the program 110.

Furthermore, for example, as illustrated in FIG. 5, the management device 1 stores application information 131, application event information 132, flow information 133, machine information 134, and workflow information 135 in the information storage region 130.

The information reception unit 111 receives, for example, the application information 131 and the application event information 132 transmitted by a business operator via a business operator's terminal (not illustrated). The application information 131 is information regarding an application AP executed in each container 3. Furthermore, the application event information 132 is information indicating a correspondence relationship between a processing request (event) transmitted from a user and an application AP that executes processing according to each processing request.

Furthermore, the information reception unit 111 receives, for example, the processing request transmitted by the user via the user's terminal.

The information management unit 112 stores the application information 131 and the application event information 132 received by the information reception unit 111 in the information storage region 130.

Furthermore, the information management unit 112 generates the flow information 133 that indicates an execution order of each application AP executed in response to receipt of the processing request by the information reception unit 111. Then, the information management unit 112 stores the generated flow information 133 in the information storage region 130.

The first application specification unit 113 refers to the application event information 132 stored in the information storage region 130 and specifies an application AP that needs to be executed in response to the receipt of the processing request received by the information reception unit 111.

The container control unit 114 activates the container 3 in which the application AP specified by the first application specification unit 113 is executed. Then, the container control unit 114 executes the application AP specified by the first application specification unit 113 in the activated container 3.

In a case where the application AP specified by the first application specification unit 113 is executed, the probability calculation unit 115 refers to the flow information 133 stored in the information storage region 130 and calculates an execution probability such that each application AP that may be executed after the application AP that is in execution is executed after the application AP that is in execution.

The second application specification unit 116 specifies an application AP to be activated in advance on the basis of the execution probability calculated by the probability calculation unit 115.

Furthermore, the second application specification unit 116 specifies an application AP that stores an image file required to execute each application AP in the physical machine 2 that executes each application AP (image file used to activate container 3 that executes each application AP) in advance on the basis of the execution probability calculated by the probability calculation unit 115.

The machine determination unit 117 determines the physical machine 2 that executes each application AP specified by the second application specification unit 116 on the basis of the machine information 134 stored in the information storage region 130, for example. The machine information 134 is information including a usage rate of a CPU of each physical machine 2 and a free space of the memory and, for example, is information transmitted from each physical machine 2 as needed.

For example, the file transmission unit 118 transmits each image file required to execute each application AP specified by the second application specification unit 116 to the physical machine 2 that executes each application AP (physical machine 2 determined by machine determination unit 117). Note that the image file required to execute each application AP may be, for example, stored in the information storage region 130. Then, for example, the file transmission unit 118 may transmit each image file required to execute each application AP specified by the second application specification unit 116 among the image files stored in the information storage region 130 to the physical machine 2 that executes each application AP. The workflow information 135 will be described later.

[Outline of First Embodiment]

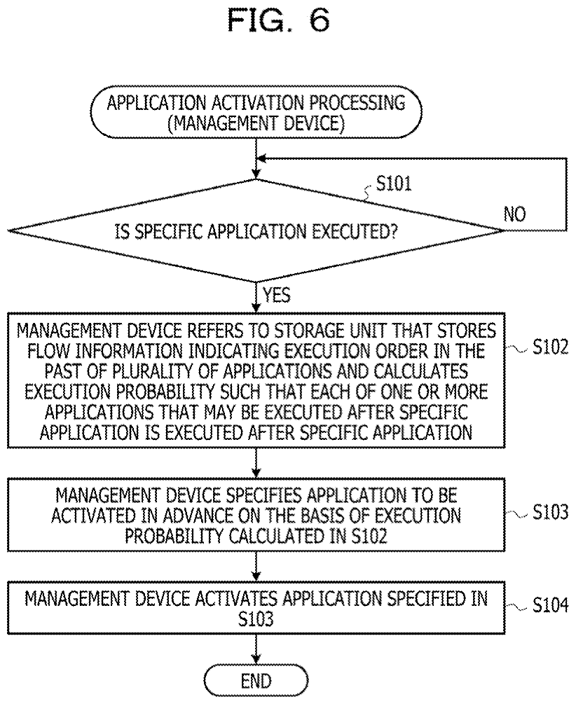

Next, an outline of a first embodiment will be described. FIG. 6 is a flowchart for explaining an outline of the application control processing according to the first embodiment.

As illustrated in FIG. 6, the management device 1 waits until a specific application AP is executed (NO in S101).

Then, in a case where the specific application AP is executed (YES in S101), the management device 1 refers to the information storage region 130 where the flow information 133 indicating the execution order of the plurality of applications AP in the past is stored and calculates an execution probability such that each of one or more applications AP that may be executed after the specific application AP is executed after the specific application AP (S102).

Subsequently, the management device 1 specifies an application AP to be activated in advance on the basis of the execution probability calculated in the processing in S102 (S103).

Thereafter, the management device 1 activates the application AP specified in the processing in S103 (S104).

That is, for example, the management device 1 according to the present embodiment specifies the application AP that has a higher possibility to be executed after the specific application AP (application AP with higher execution probability) on the basis of an activation order of each application AP in the past. Then, the management device 1 only activates the specified application AP in advance.

As a result, for example, the management device 1 according to the present embodiment can shorten the response time to the processing request while suppressing the consumption of the physical resource of the physical machine 2.

[Details of First Embodiment]

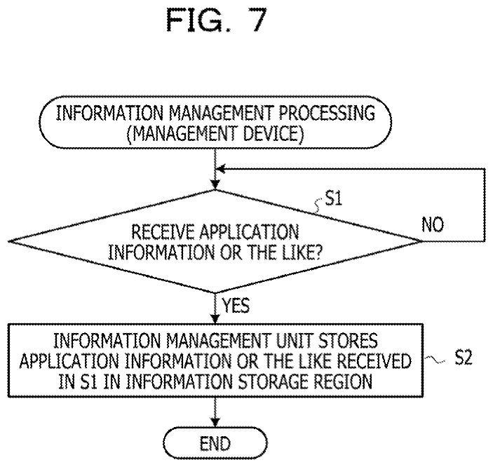

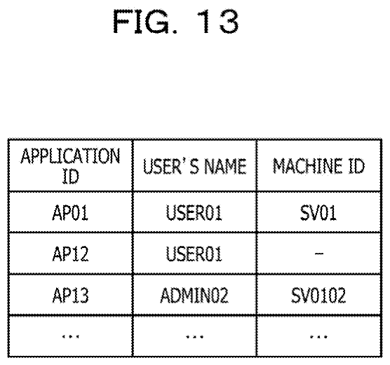

Next, details of the first embodiment will be described. FIGS. 7 to 12 are flowcharts for explaining details of the application control processing according to the first embodiment. Furthermore, FIGS. 13 to 25 are diagrams for explaining details of the application control processing according to the first embodiment

[Information Management Processing]

First, processing for managing the application information 131 and the application event information 132 (hereinafter, also referred to as information management processing) in the application control processing will be described. FIG. 7 is a flowchart for explaining the information management processing.

As illustrated in FIG. 7, the information reception unit 111 of the management device 1 waits, for example, until the application information 131 or the application event information 132 is received from a business operator's terminal (not illustrated) (NO in S1).

Then, in a case where the application information 131 or the application event information 132 is received (YES in S1), the information management unit 112 stores the application information 131 or the application event information 132 received in the processing in S1 in the information storage region 130 (S2), Hereinafter, specific examples of the application information 131 and the application event information 132 will be described.

### Specific Example of Application Information

First, the specific example of the application information 131 will be described. FIG. 13 is a diagram for explaining the specific example of the application information 131.

The application information 131 illustrated in FIG. 13 includes, as items, an “application ID” used to identify each application AP, a “user's name” used to identify a user who uses each application AP, and a “machine ID” used to identify a physical machine 2 that stores an image file (not illustrated) required to execute each application AP.

Specifically, for example, in the application information 131 illustrated in FIG. 13, with respect to information in the first row, “AP01” is set as the “application ID”, “USER01” is set as the “user's name”, and “SV01” is set as the “machine ID”.

Furthermore, in the application information 131 illustrated in FIG. 13, with respect to information in the second row, “AP02” is set as the “application ID”, “USER01” is set as the “user's name”, and “-” indicating that no physical machine 2 that stores an image file exists is set as the “machine ID”. The description of other information included in FIG. 13 will be omitted.

### Specific Example of Application Event Information

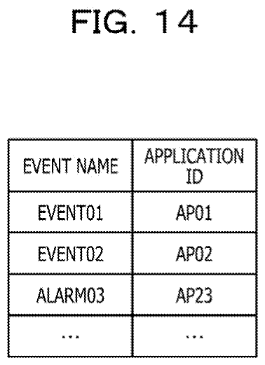

Next, the specific example of the application event information 132 will be described. FIG. 14 is a diagram for explaining the specific example of the application event information 132.

The application event information 132 illustrated in FIG. 14 includes, as items, an “event name” used to identify each processing request transmitted from the user's terminal and an “application ID” used to identify each application AP.

Specifically, for example, in the application event information 132 illustrated in FIG. 14, with respect to information in the first row, “EVENT01” is set as the “event name”, and “AP01” is set as the “application ID”.

Furthermore, in the application event information 132 illustrated in FIG. 14, with respect to information in the second row, “EVENT02” is set as the “event name”, and “AP02” is set as the “application ID”. The description of other information included in FIG. 14 will be omitted.

[Main Processing of Application Control Processing]

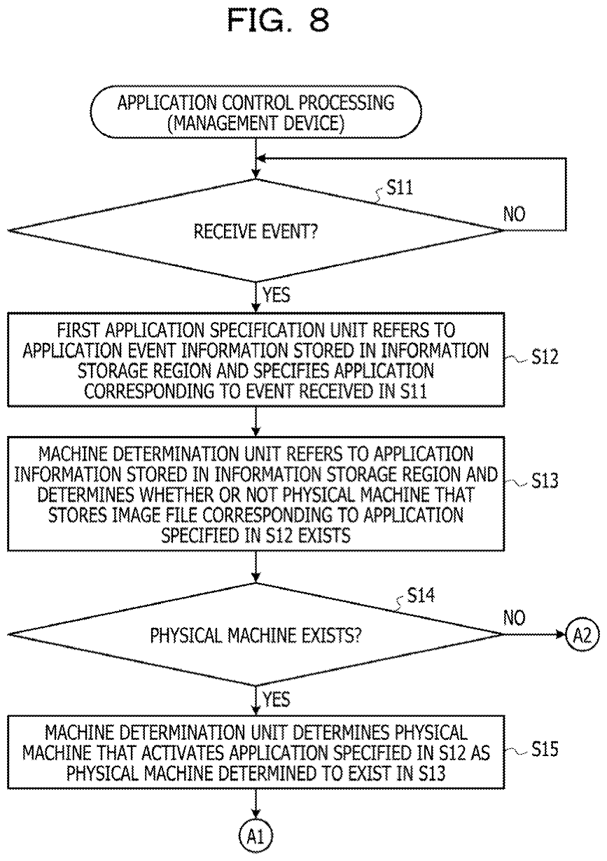

Next, main processing of the application control processing will be described. FIGS. 8 to 11 are flowcharts for explaining the main processing of the application control processing.

As illustrated in FIG. 8, the information reception unit 111 waits, for example, until a processing request is received from the user's terminal (NO in S11).

Then, in a case where the processing request is received (YES in S11), the first application specification unit 113 of the management device 1 refers to the application event information 132 stored in the information storage region 130 and specifies an application AP corresponding to the processing request received in the processing in S11 (S12).

Specifically, for example, in the application event information 132 illustrated in FIG. 14, with respect to information to which “EVENT01” is set (information in first row) as the “event name”, “AP01” is set as the “application ID”. Therefore, for example, in a case where an “event name” of an event corresponding to the processing request received in the processing in S11 is “EVENT01”, the first application specification unit 113 specifies an application AP of which the “application ID” is “AP01”.

Subsequently, the machine determination unit 117 of the management device 1 refers to the application information 131 stored in the information storage region 130 and determines whether or not a physical machine 2 that stores an image file corresponding to the application AP specified in the processing in S12 exists (S13).

Specifically, for example, in the application information 131 illustrated in FIG. 13, with respect to information of which the “application ID” is “AP01” (information in first row), “SV01” is set as the “machine ID”. Therefore, for example, in a case where the “application ID” of the application AP specified in the processing in S12 is “AP01”, the machine determination unit 117 specifies a physical machine 2 of which the “machine ID” is “SV01” as the physical machine 2 that stores the image file corresponding to the application AP specified in the processing in S12.

Then, in a case where it is determined that the physical machine 2 exists (YES in S14), the machine determination unit 117 determines the physical machine 2 that activates the application AP specified in the processing in S12 as the physical machine 2 that is determined to exist in the processing in S13 (S15).

That is, for example, the machine determination unit 117 determines the physical machine 2 that stores the image file required to execute each application AP as the physical machine 2 that activates the application AP specified in the processing in S12.

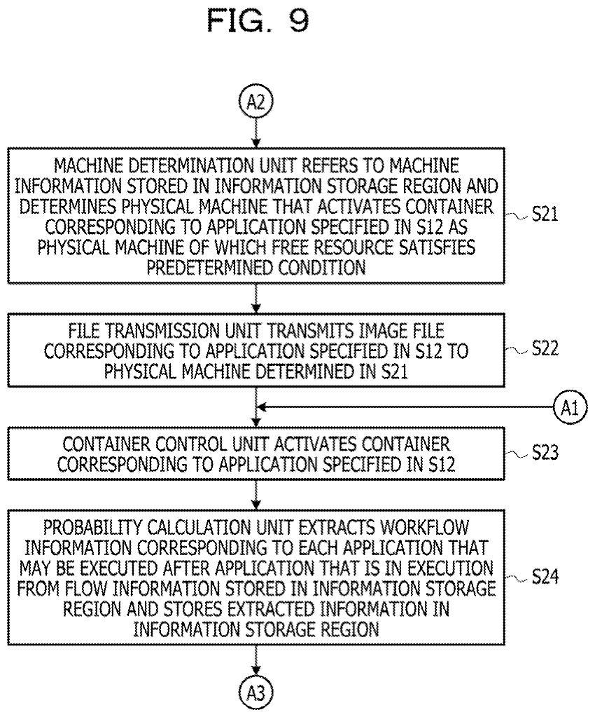

On the other hand, in a case where it is determined that the physical machine 2 does not exist (NO in S14), the machine determination unit 117, as illustrated in FIG. 9, refers to the machine information 134 stored in the information storage region 130 and determines the physical machine 2 that activates the container 3 corresponding to the application AP specified in the processing in S12 as any one of physical machines 2 of which free resources satisfy a predetermined condition (S21).

Specifically, for example, the machine determination unit 117 determines, for example, a physical machine 2 of which a usage rate of a CPU is equal to or less than a threshold (hereinafter, also referred to as CPU threshold) and a free space of a memory is equal to or more than a threshold (hereinafter, also referred to as memory threshold) as the physical machine 2 that activates the container 3 corresponding to the application AP specified in the processing in S12. Hereinafter, a specific example of the machine information 134 will be described.

### Specific Example of Machine Information

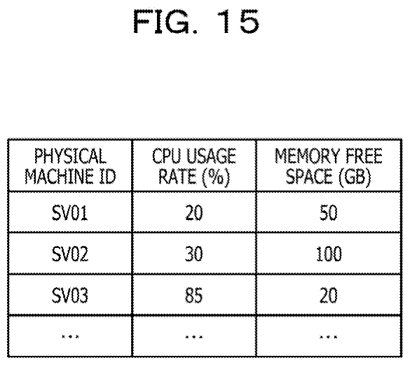

FIG. 15 is a diagram for explaining the specific example of the machine information 134.

The machine information 134 illustrated in FIG. 15 includes, as items, a “physical machine ID” used to identify each physical machine 2, a “CPU usage rate” to which the usage rate of the CPU of each physical machine 2 is set, and a “memory free space” to which the free space of the memory of each physical machine 2 is set.

Specifically, in the machine information 134 illustrated in FIG. 15, with respect to information in the first row, “SV01” is set as the “physical machine ID”, “20(%)” is set as the “CPU usage rate”, and “50 (GB)” is set as the “memory free space”.

Furthermore, in the machine information 134 illustrated in FIG. 15, with respect to information in the second row, “SV02” is set as the “physical machine ID”, “30(%)” is set as the “CPU usage rate”, and “100 (GB)” is set as the “memory free space”. The description of other information included in FIG. 15 will be omitted.

Therefore, for example, in a case where the CPU threshold is 50(%) and the memory threshold is 50 (GB), the machine determination unit 117 determines a physical machine 2 of which the value set to the “CPU usage rate” is equal to or less than 50(%) and the value set to the “memory free space” is equal to or more than 50 (GB) (for example, physical machine 2 of which “physical machine ID” is “SV02”) as the physical machine 2 that activates the container 3 corresponding to the application AP specified in the processing in S12.

Returning to FIG. 9, the file transmission unit 118 of the management device 1 transmits the image file required to execute the application AP specified in the processing in S12 to the physical machine 2 determined in the processing in S21 (S22).

Then, the container control unit 114 activates the container 3 corresponding to the application AP specified in the processing in S12 in the physical machine 2 determined in the processing in S15 or S21, and further executes the application AP specified in the processing in S12 in the activated container 3 (S23).

Note that, in a case of determining that the physical machine 2 that stores the image file required to execute the application AP specified in the processing in S12 exists (YES in S14) the management device 1 may determine whether or not a free resource of the physical machine 2 satisfies a predetermined condition (predetermined condition in processing in S21). Then, in a case of determining that the free resource does not satisfy the predetermined condition, the management device 1 may execute the processing in S21 and S22.

Subsequently, the probability calculation unit 115 of the management device 1 extracts information (hereinafter, also referred to as workflow information 135) corresponding to each application AP that may be executed after the application AP that is in execution (application AP specified in processing in S12) from information included in the flow information 133 stored in the information storage region 130 and stores the extracted information in the information storage region 130 (S24). Hereinafter, a specific example of the flow information 133 will be described.

### Specific Example of Flow Information

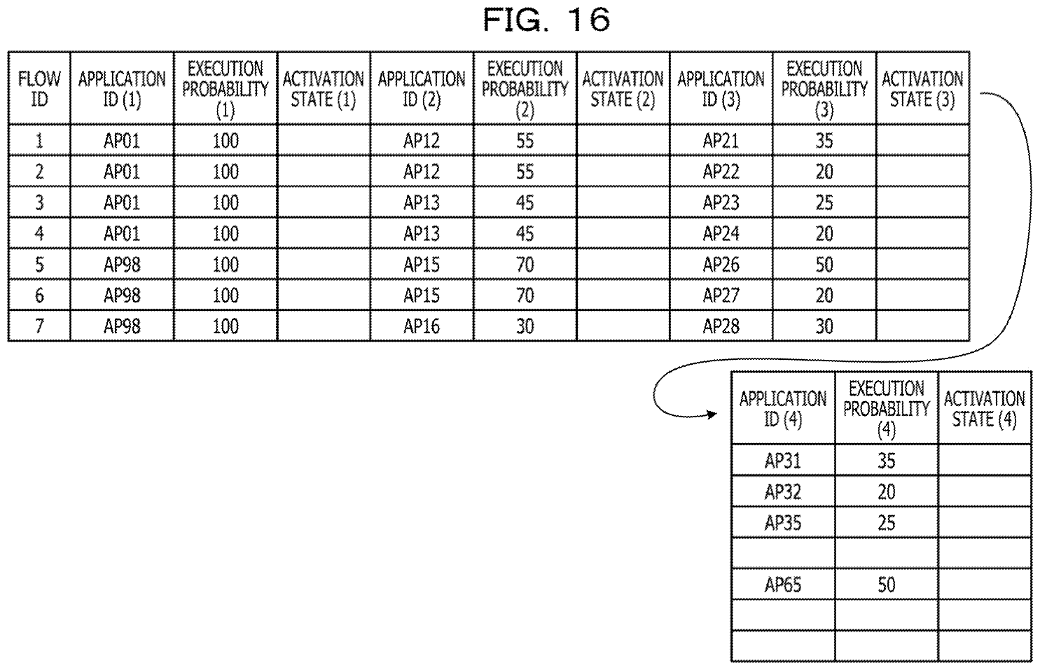

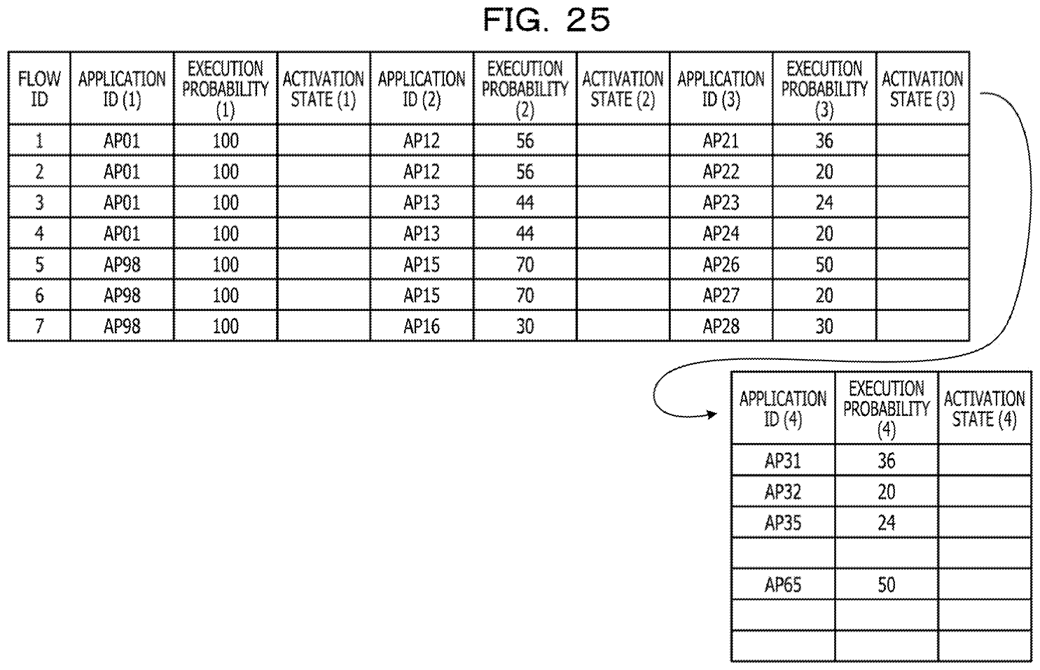

FIGS. 16 and 25 are diagrams for explaining specific examples of the flow information 133.

The flow information 133 illustrated in FIG. 16 or the like includes, as items, a “flow ID” used to identify an execution order of each application AP (hereinafter, also referred to as flow), an “application ID” used to identify each application AP, an “execution probability” indicating a probability such that each application AP is executed, and an “activation state” indicating an activation state of the container 3 in which each application AP is executed. Note that, in the flow information 133 illustrated in FIG. 16 or the like, the “application ID” corresponding to four applications AP at the maximum included in each flow, the “execution probability”, and the “activation state” are set.

Specifically, for example, in the flow information 133 illustrated in FIG. 16, with respect to information in the first row to information in the fourth row, “1” to “4” are respectively set as the “flow IDs”, “AP01” is set as the “application ID (1)”, and “100(%)” is set as the “execution probability (1)”.

Then, in the flow information 133 illustrated in FIG. 16, with respect to the information in the first and second rows, “AP12” is set as the “application ID (2)”, and “55(%)” is set as the “execution probability (2)”. Furthermore, in the flow information 133 illustrated in FIG. 16, with respect to the information in the third and fourth rows, “AP13” is set as the “application ID (2)”, and “45(%)” is set as the “execution probability (2)”.

Moreover, in the flow information 133 illustrated in FIG. 16, with respect to the information in the first row, “AP21” is set as the “application ID (3)”, “35(%)” is set as the “execution probability (3)”, “AP31” is set as the “application ID (4)”, and “35(%)” is set as the “execution probability (4)”. Furthermore, in the flow information 133 illustrated in FIG. 16, with respect to the information in the second row, “AP22” is set as the “application ID (3)”, “20(%)” is set as the “execution probability (3)”, “AP32” is set as the “application ID (4)”, and “20(%)” is set as the “execution probability (4)”. Furthermore, in the flow information 133 illustrated in FIG. 16, with respect to the information in the third row, “AP23” is set as the “application ID (3)”, “25(%)” is set as the “execution probability (3)”, “AP35” is set as the “application ID (4)”, and “25(%)” is set as the “execution probability (4)”.

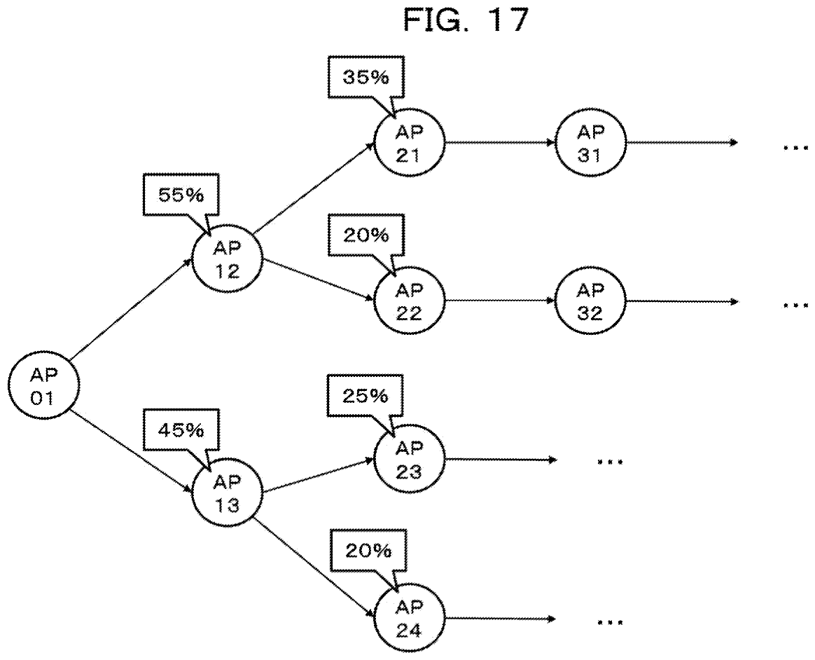

That is, for example, the flow information 133 illustrated in FIG. 16 indicates that, as illustrated in FIG. 17, in a case where an application AP of which the “application ID” is “AP01” is executed in a predetermined period in the past (for example, previous week), an application AP of which the “application. ID” is “AP12” is executed with the probability of 55(%) and the application AP of which an “application ID” is “AP13” is executed with the probability of 45(%) immediately after the execution of the above application AP.

Furthermore, the flow information 133 illustrated in FIG. 16 indicates that, as illustrated in FIG. 17, in a case where the application AP of which the “application ID” is “AP01” is executed, immediately after the execution of the application AP of which the “application ID” is “AP12”, an application AP of which the “application ID” is “AP21” is executed with the probability of 35(%), and an application AP of which the “application ID” is “AP22” is executed with the probability of 20(%).

Furthermore, the flow information 133 illustrated in FIG. 16 indicates that, as illustrated in FIG. 17, in a case where the application AP of which the “application ID” is “AP01” is executed, immediately after the execution of the application AP of which the “application ID” is “AP13”, an application AP of which the “application ID” is “AP23” is executed with the probability of 25(%), and an application AP of which the “application ID” is “AP24” is executed with the probability of 20(%).

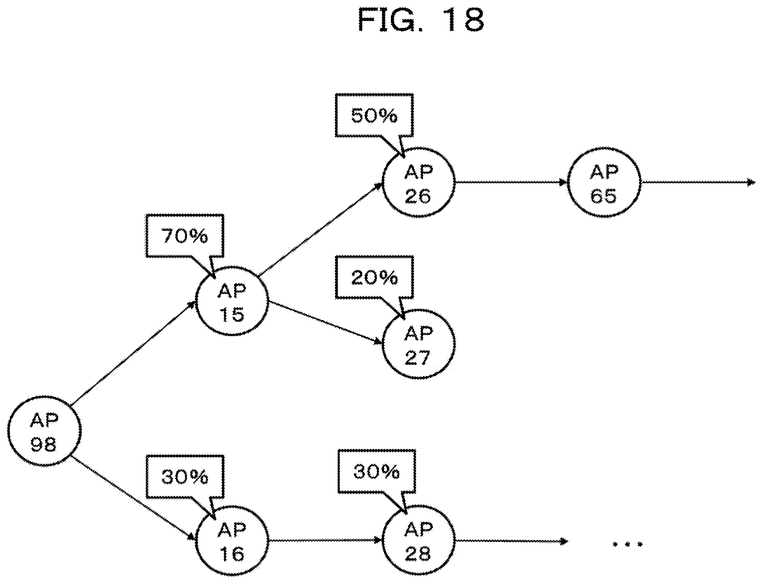

Similarly, the flow information 133 illustrated in FIG. 16 indicates that, as illustrated in FIG. 18, in a case where an application AP of which the “application ID” is “AP98” is executed in a predetermined period in the past (for example, previous week), immediately after the execution of the above application AP, an application AP of which the “application ID” is “AP15” is executed with the probability of 70(%) and an application AP of which the “application ID” is “AP16” is executed with the probability of 30(%).

Furthermore, the flow information 133 illustrated in FIG. 16 indicates that, as illustrated in FIG. 18, in a case where the application AP of which the “application ID” is “AP98” is executed, immediately after the execution of the application AP of which the “application ID” is “AP15”, an application AP of which the “application ID” is “AP26” is executed with the probability of 50(%), and an application AP of which the “application ID” is “AP27” is executed with the probability of 20(%).

Furthermore, the flow information 133 illustrated in FIG. 16 indicates that, as illustrated in FIG. 18, in a case where the application AP of which the “application ID” is “AP98” is executed, immediately after the execution of the application AP of which the “application ID” is “AP16”, an application AP of which the “application ID” is “AP28” is executed with the probability of 30(%).

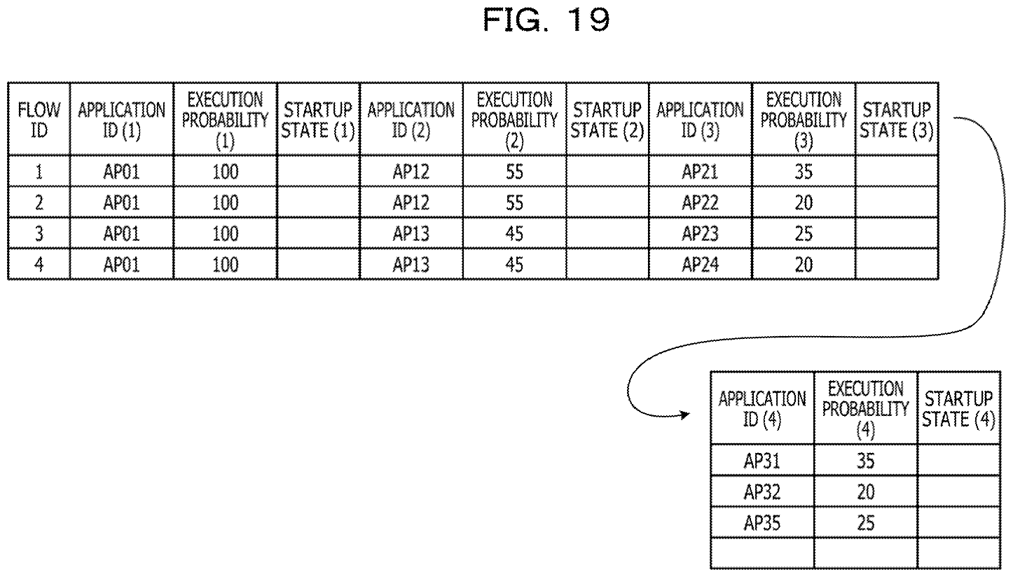

Therefore, for example, in a case where the execution of the application AP of which the “application ID” is “AP01” is started, as illustrated in FIG. 19, the probability calculation unit 115 extracts, in the processing in S24, information corresponding to the application AP of which the “application ID” is “AP01” (information in first row to fourth row) from the information included in the flow information 133 illustrated in FIG. 16 as the workflow information 135.

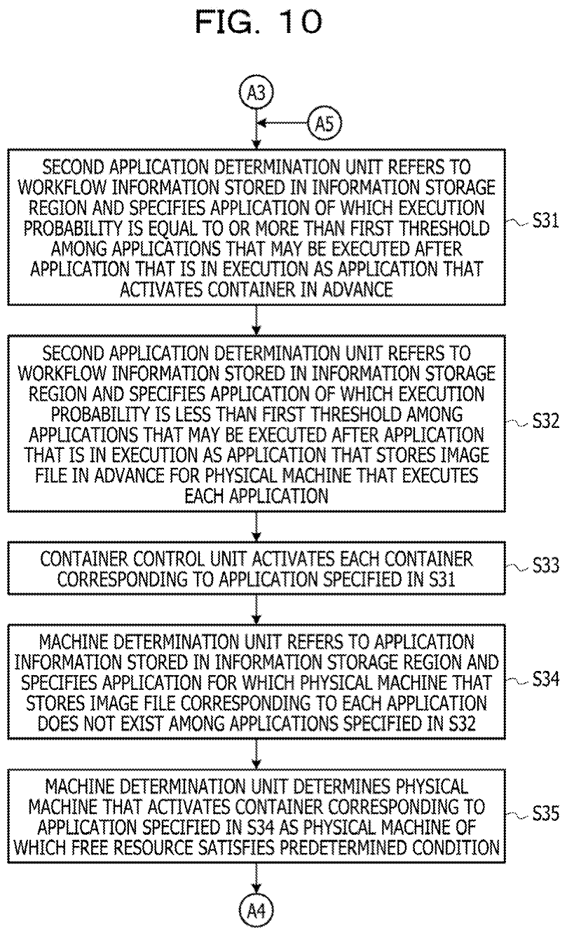

Returning to FIG. 10, the second application specification unit 116 of the management device 1 refers to the workflow information 135 stored in the information storage region 130 and specifies an application AP of which an execution probability is equal to or more than a first threshold from among the applications AP that may be executed after the application AP that is in execution as the application AP that activates the container 3 in advance (S31).

Furthermore, the second application specification unit 116 refers to the workflow information 135 stored in the information storage region 130 and specifies an application AP of which an execution probability is less than the first threshold among the applications AP that may be executed after the application AP that is in execution as the application AP that stores the image file in advance for the physical machine 2 that executes each application AP (S32).

Specifically, for example, the second application specification unit 116 refers to the workflow information 135 stored in the information storage region 130 and specifies each application AP of which the number of applications AP executed before the execution of each application AP, after the execution of the application AP that is in execution is equal to or less than a predetermined number (for example, equal to or less than two). Then, the second application specification unit 116 specifies the application AP of which the execution probability is equal to or more than the first threshold, among the specified applications AP, as the application AP that activates the container 3 for executing each application AP in advance. Furthermore, the second application specification unit 116 specifies the application AP of which the execution probability is less than the first threshold among the specified applications AP as the application AP that stores the image file in advance for the physical machine 2 that executes each application AP (application AP that does not activate container 3 in advance).

More specifically, for example, in the flow information 133 illustrated in FIG. 19, for example, applications AP of which the number of applications AP to be executed before the execution of each application AP, after the execution of the application AP of which the “application ID” is “AP01” is equal to or less than two are the applications AP each having the “application IDs” of “AP12”, “AP13”, “AP21”, “AP22”, “AP23”, and “AP24”. Then, in the flow information 133 illustrated in FIG. 19, execution probabilities of the applications AP having the “application IDs” of “AP12”, “AP13”, “AP21”, “AP22”, “AP23”, and “AP24” are respectively “55(%)”, “45(%)”, “35(%)”, “20(%)”, “25(%)”, and “20(%)”.

Therefore, for example, in a case where the first threshold is equal to or more than 35(%), the second application specification unit 116 specifies “AP12”, “AP13”, and “AP21” that are the “application IDs” of the applications AP of which the “execution probability” is equal to or more than “35(%)” in the processing in S31.

Furthermore, the second application specification unit 116 specifies “AP22”, “AP23”, and “AP24” that are the “application IDs” of the applications AP of which the “execution probability” is less than “35(%)” in the processing in S32 in this case.

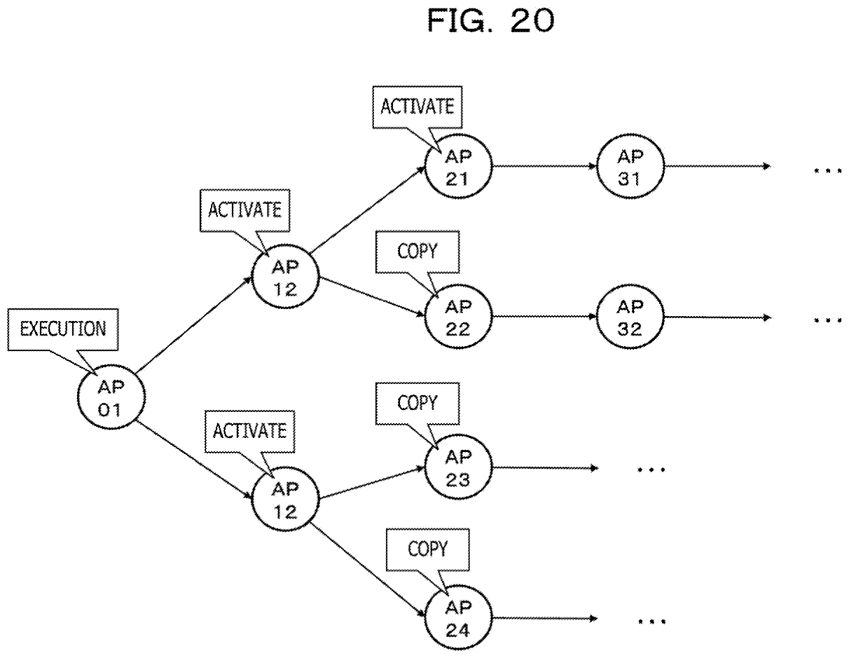

That is, for example, as illustrated in FIG. 20, the second application specification unit 116 determines “AP12”, “AP13”, and “AP21.” that are the “application IDs” of the applications AP of which the “execution probability” is equal to or more than “35(%)” as applications AP that have a high possibility to be executed after the application AP that is in execution and specifies the determined applications AP as applications AP that activate the container 3 that executes each application AP in advance. Furthermore, the second application specification unit 116 determines “AP22”, “AP23”, and “AP24” that are the “application IDs” of the applications AP of which the “execution probability” is less than “35(%)” as applications AP of which the possibility to be executed after the application AP that is in execution is not high and specifies the determined applications AP as the application AP that stores (copies) the image file in advance in the physical machine 2 that executes each application AP.

As a result, the management device 1 activates, in advance, only the container 3 corresponding to the application AP that can be determined to have a high possibility to be executed after the application AP that is in execution. Therefore, the management device 1 can suppress the number of containers 3 to be activated in advance and can suppress the response time to the processing request while suppressing the consumption of the physical resource of the physical machine 2.

Returning to FIG. 10, the container control unit 114 activates each container 3 corresponding to the application AP specified in the processing in S31 (S33).

Note that the container control unit 114 may activate only the container 3 of which an activation time in the past (for example, average of activation time in the past) is equal to or more than a predetermined threshold, for example, among the containers 3 corresponding to the applications AP specified in the processing in S31.

Then, the machine determination unit 117 refers to the application information 131 stored in the information storage region 130 and specifies the application AP for which the physical machine 2 that stores the image file required to execute each application AP does not exist from among the applications AP specified in the processing in S32 (S34).

That is, for example, the machine determination unit 117 specifies the application AP that needs to transmit the image file to any one of the physical machines 2 from among the applications AP specified in the processing in S32.

Subsequently, the machine determination unit 117 determines the physical machine 2 that activates the container 3 corresponding to the application AP specified in the processing in S34 as the physical machine 2 of which the free resource satisfies the predetermined condition (S35).

Specifically, for example, as in a case of the processing in S21, the machine determination unit 117 determines, for example, the physical machine 2 of which the usage rate of the CPU is equal to or less than the CPU threshold and the free space of the memory is equal to or more than the memory threshold as the physical machine 2 that activates the container 3 corresponding to the application AP specified in the processing in S34.

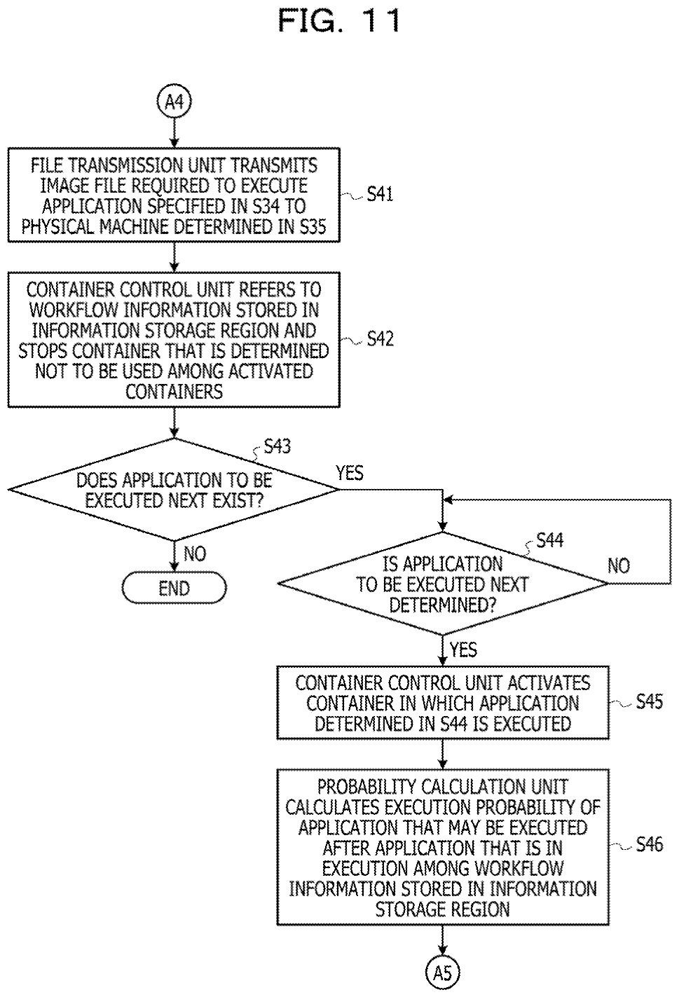

Moreover, as illustrated in FIG. 11, the file transmission unit 118 transmits the image file required to execute the application AP specified in the processing in S34 to the physical machine 2 determined in the processing in S35 (S41).

Thereafter, the container control unit 114 refers to the workflow information 135 stored in the information storage region 130 and stops the container 3 that is determined not to be used from among the activated containers 3 (S42).

Specifically, for example, the container control unit 114 refers to the workflow information 135 stored in the information storage region 130 and determines whether or not the application AP that is determined not to be executed after the application AP that is in execution is included in the applications AP that are executed in the activated container 3. Then, in a case of determining that the application AP that is determined not to be executed after the application AP that is in execution exists, the container control unit 114 stops the container 3 in which the application AP that is determined to exist is executed.

As a result, the management device 1 can further suppress the consumption of the physical resource of the physical machine 2.

Note that the information management unit 112 may update the workflow information 135 stored in the information storage region 130 as needed, for example, according to the execution of the processing in S23, S33, S41, and S42.

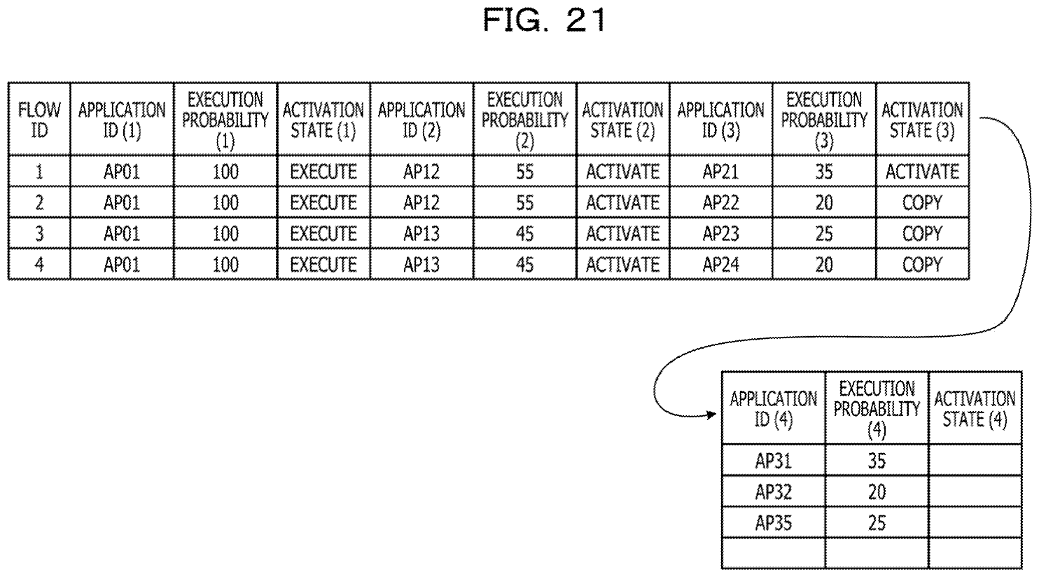

Specifically, for example, the information management unit 112 may set “execute” to the “activation state” corresponding to the application AP that is in execution in the container 3 activated in the processing in S23, for example, as illustrated in FIG. 21. Furthermore, the information management unit 112 may set “activate” to the “activation state” corresponding to the application AP executed in the container 3 activated in the processing in S33, for example. Furthermore, the information management unit 112 may set “copy” to the “activation state” corresponding to the application AP that stores (copies) the image file in the processing in S41 or the like, for example. Moreover, as described later, the information management unit 112 may set “stop” to the “activation state” corresponding to the application AP executed in the container 3 that is stopped in the processing in S42, for example.

Returning to FIG. 11, the container control unit 114 refers to the workflow information 135 stored in the information storage region 130 and determines whether or not an application AP to be executed after the application AP that is in execution exists (S43).

As a result, in a case where it is determined that the application AP to be executed after the application AP that is in execution does not exist (NO in S43), the management device 1 ends the execution of the main processing of the application control processing.

On the other hand, in a case where it is determined that the application AP to be executed after the application AP that is in execution exists (YES in S43), the management device 1 waits until an application AP to be executed next is determined according to the end of the execution of the application AP that is in execution (NO in S44).

Then, in a case where the application AP to be executed next is determined (YES in S44), the container control unit 114 activates a container 3 in which the application AP determined in the processing in S44 is executed and further executes the application AP determined in the processing in S44 (S45).

Specifically, for example, in this case, the container control unit 114 determines whether or not the container 3 in which the application AP determined in the processing in S44 is executed has been already activated. Then, in a case where it is determined that the container 3 in which the application AP determined in the processing in S44 is executed has not been activated yet, the container control unit 114 activates the container 3 in which the application AP determined in the processing in S44 is executed.

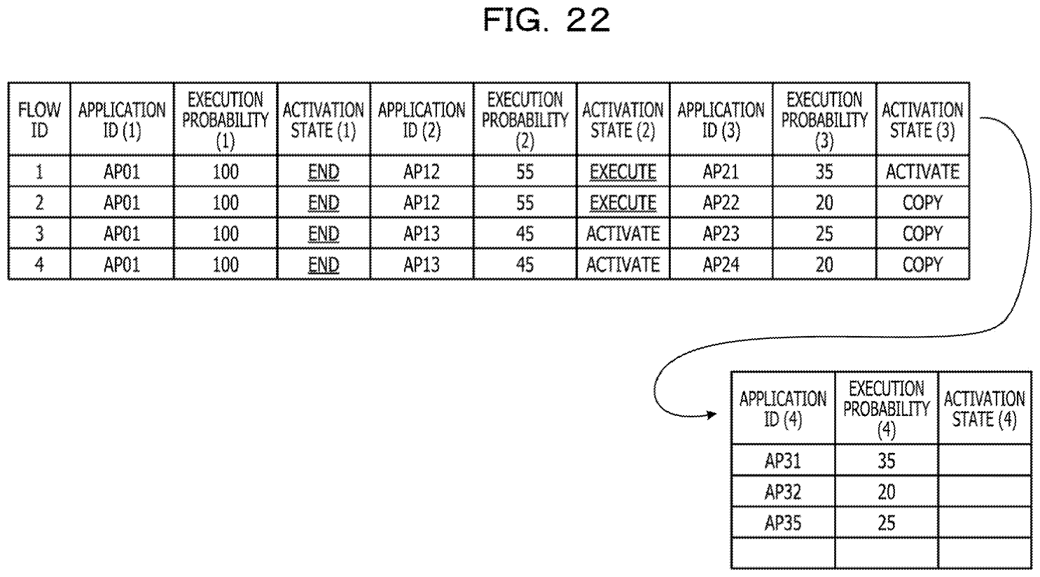

Note that, in this case, for example, as illustrated in the underlined portion in FIG. 22, the information management unit 112 sets “end” to the “activation state” corresponding to the application AP of which the execution ends, and sets “execute” to the “activation state” corresponding to the application AP of which execution is newly started.

Subsequently, the probability calculation unit 115 calculates an execution probability of an application AP that may be executed after the application that is in execution among information included in the workflow information 135 stored in the information storage region 130 (S46). Then, the management device 1 executes the processing in S31 and subsequent processing again after the processing in S46.

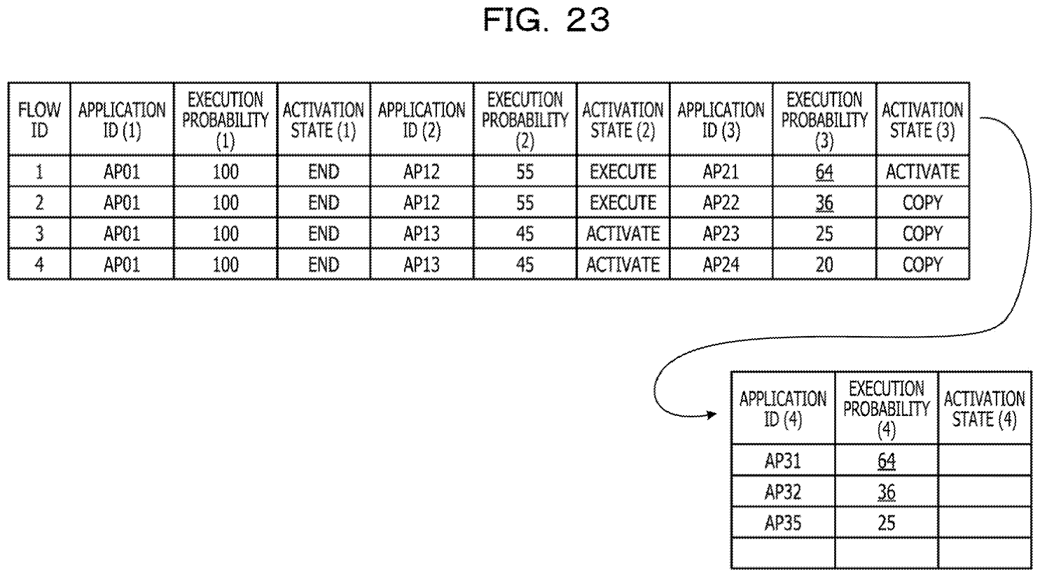

Specifically, for example, in a case where the application AP of which the “application ID” is “AP12” is executed after the application AP of which the “application ID” is “AP01” is executed, the probability calculation unit 115 calculates a probability such that each of the applications AP of which the “application IDs” are “AP21”, “AP22”, “AP31”, and “AP32” is executed after the execution of the application AP of which the “application ID” is “AP12” as illustrated in FIG. 23.

More specifically, for example, in the workflow information 135 illustrated in FIG. 22, the “execution probability” corresponding to the application AP of which the “application ID” is “AP12” is “55(%)”, the “execution probability” corresponding to the applications AP of which the “application IDs” are “AP21” and “AP31” is “35(%)”, and the “execution probability” corresponding to the applications AP of which the “application IDs” are “AP22” and “AP32” is “20(%)”. Therefore, the probability calculation unit 115 calculates a new execution probability corresponding to the applications AP of which the “application IDs” are “AP21” and “AP31” as “64(%)” by dividing “35(%)” by “0.55” corresponding to “55(%)”. Furthermore, the probability calculation unit 115 calculates a new execution probability corresponding to the applications AP of which the “application IDs” are “AP22” and “AP32” as “36(%)” by dividing “20(%)” by “0.55” corresponding to “55(%)”.

Then, as illustrated in the underlined portion in FIG. 23, for example, the information management unit 112 updates the “execution probability” corresponding to the applications AP of which the “application IDs” are “AP21” and “AP31” to “64(%)” and updates the “execution probability” corresponding to the applications AP of which the “application IDs” are “AP22” and “AP32” to “36(%)”.

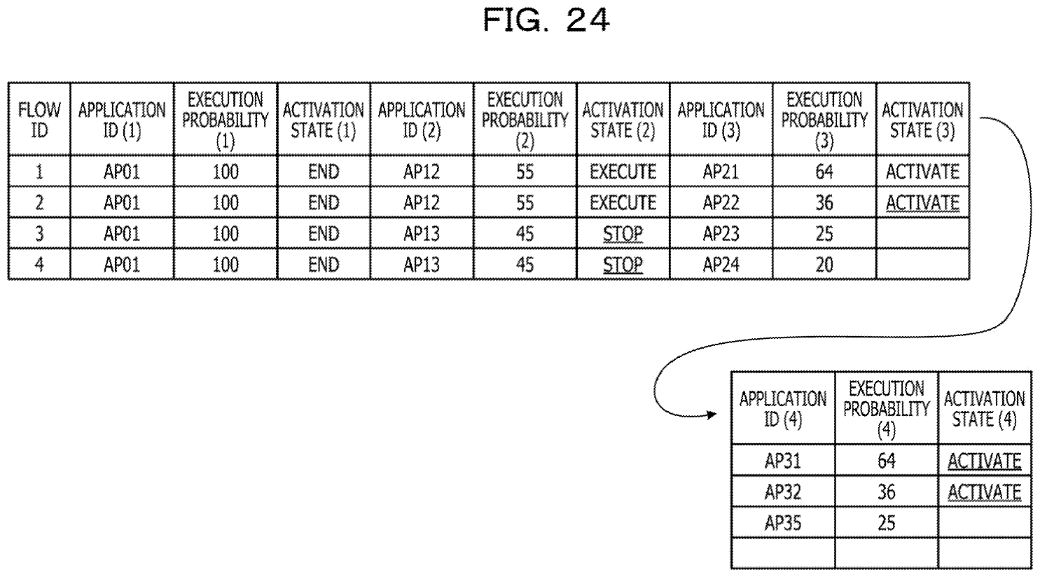

Thereafter, the second application specification unit 116 determines that all execution probabilities of the applications AP of which the “application IDs” are “AP22”, “AP31”, and “AP32” are equal to or more than 35(%) in the processing in S31 for the second time. Therefore, the container control unit 114 activates the container 3 in which each of the applications AP of which the “application IDs” are “AP22”, “AP31”, and “AP32” is executed in the processing in S33 for the second time. Then, as illustrated in the underlined portion in FIG. 24, for example, the information management unit 112 sets “activate” to the “activation state” corresponding to the applications AP of which the “application IDs” are “AP22”, “AP31”, and “AP32”.

Moreover, the container control unit 114 stops the container 3 (activated container 3) in which the application AP of which the “application ID” is “AP13” is executed in the processing in S42 for the second time. Then, as illustrated in the underlined portion in FIG. 24, for example, the information management unit 112 updates the “activation state” corresponding to the application AP of which the “application ID” is “AP13” to “stop”. Furthermore, for example, the information management unit 112 sets a blank to the “activation state” corresponding to the applications AP of which the “application IDs” are “AP23” and “AP24” (application AP that may be executed after application AP of which “application ID” is “AP13”).

[Information Update Processing]

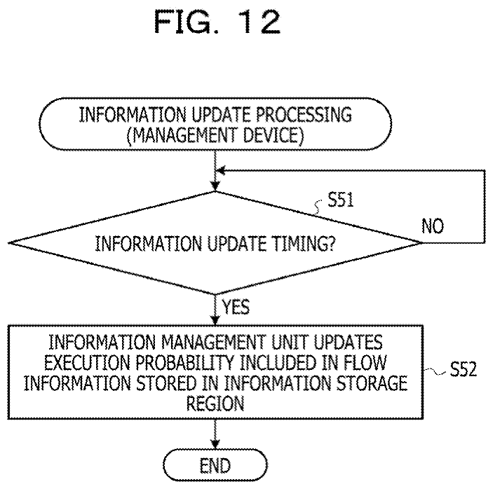

Next, processing for updating the flow information 135 (hereinafter, also referred to as information update processing) in the application control processing will be described. FIG. 12 is a flowchart for explaining an information update device.

As illustrated in FIG. 12, the information management unit 112 waits, for example, until it becomes an information update timing (NO in S51). The information update timing may be, for example, a timing when the main processing of the application control processing ends. Furthermore, the information update timing may be a periodical timing, for example, once in an hour or the like.

Then, in a case where it becomes the information update timing (YES in S51), the information management unit 112 updates each execution probability included in the flow information 133 stored in the information storage region 130 (S52).

Specifically, for example, the probability calculation unit 115 recalculates each execution probability included in the flow information 133 stored in the information storage region 130 (execution probability of each application AP). Then, as illustrated in FIG. 25, the information management unit 112 updates each execution probability included in the flow information 133 stored in the information storage region 130 to the recalculated execution probability.

In this way, in a case where a specific application AP included in the plurality of applications AP is executed, the management device 1 according to the present embodiment refers to a storage unit that stores the flow information indicating the execution order of the plurality of applications AP in the past and calculates an execution probability such that each of one or more applications AP that may be executed after the specific application AP is executed after the specific application AP. Then, the management device 1 specifies an application AP to be activated on the basis of the calculated execution probability.

That is, for example, the management device 1 according to the present embodiment specifies an application AP that has a higher possibility to be executed after the specific application AP (application AP having higher execution probability) among the applications AP that may be executed after the specific application AP on the basis of the activation order of each application AP in the past. Then, the management device 1 only activates the specified application AP in advance.

As a result, for example, the management device 1 according to the present embodiment can shorten the response time to the processing request while suppressing the consumption of the physical resource of the physical machine 2.

Note that, in the example described above, it has been described that it is assumed that the first threshold used in the processing in S31 and S32 be determined in advance. However, the first threshold may be determined as needed, for example, according to the number of applications AP that may be executed after the application AP that is in execution, or the like.

Specifically, for example, the first threshold may be, for example, a reciprocal of the number of applications AP that may be executed after an application AP subsequent to the application AP that is in execution or may be a reciprocal of a number obtained by adding a predetermined number (for example, one) to the number of applications AP that may be executed after an application AP subsequent to the application AP that is in execution.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
refer, in a case where a specific application included in a plurality of applications is executed, refer to a storage unit that stores flow information that indicates an execution order of the plurality of applications in the past and calculate an execution probability that each of one or more applications that may be executed after the specific application among the plurality of applications is executed after the specific application;
specify an application to be activated from the one or more applications on the basis of the calculated execution probability; and
activate the specified application to be activated.

2. The information processing device according to claim 1, wherein
the processor
specifies an application of which the number of other applications to be executed after the specific application and before each application is executed among the plurality of applications is equal to or less than a predetermined number as the one or more applications, and
calculates the execution probability corresponding to each of the specified one or more applications.

3. The information processing device according to claim 1, wherein
in a case where the specific application is executed in a predetermined period in the past, the processor calculates a probability that each of the one or more applications is executed after the specific application as the execution probability.

4. The information processing device according to claim 1, wherein
the processor specifies an application of which the execution probability is equal to or more than a first threshold among the one or more applications as the application to be activated.

5. The information processing device according to claim 4, wherein
the processor specifies an application of which the execution probability is less than the first threshold among the one or more applications as an application that stores an image file required to execute each application in another information processing device that executes each application.

6. The information processing device according to claim 1, wherein
the plurality of applications is an application executed in each of a plurality of containers, and
the processor
activates a container in which the application to be activated is executed in another information processing device, and
activates the application to be activated in the activated container.

7. A non-transitory computer-readable recording medium storing an application control program causing a computer to execute processing of:
referring, in a case where a specific application included in a plurality of applications is executed, refer to a storage unit that stores flow information that indicates an execution order of the plurality of applications in the past and calculate an execution probability that each of one or more applications that may be executed after the specific application among the plurality of applications is executed after the specific application;
specifying an application to be activated from the one or more applications on the basis of the calculated execution probability; and
activating the specified application to be activated.

8. The non-transitory computer-readable recording medium according to claim 7, further comprising:
specifying an application of which the number of other applications to be executed after the specific application and before each application is executed among the plurality of applications is equal to or less than a predetermined number as the one or more applications, and
calculating the execution probability corresponding to each of the specified one or more applications.

9. The non-transitory computer-readable recording medium according to claim 7, further comprising:
calculating, in a case where the specific application is executed in a predetermined period in the past, a probability that each of the one or more applications is executed after the specific application as the execution probability.

10. The non-transitory comp r-readable recording medium according to claim 7, further comprising:
specifying an application of which the execution probability is equal to or more than a first threshold among the one or more applications as the application to be activated.

11. The non-transitory computer-readable recording medium according to claim 10, further comprising:
specifying an application of which the execution probability is less than the first threshold among the one or more applications as an application that stores an image file required to execute each application in another information processing device that executes each application.

12. The non-transitory computer-readable recording medium according to claim 7, wherein
the plurality of applications is an application executed in each of a plurality of containers, and
the processing further includes activating the application to be activated in the activated container.
